(19) United States
(12) Patent Application Publication
(10) Pub. No.: US 2009/0163638 A1
(43) Pub. Date: Jun. 25, 2009

(54) Dispersion of deagglomerated barium sulphate in halogenated solvents, ethers or esters

(75) Inventors: Ferdinand Hardinghaus, Bad Honnef (DE); Karl Köhler, Diekholzen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Solvay Infra Bad Hoenningen GmbH, Hannover (DE)

(21) Appl. No.: 11/916,340

(22) PCT Filed: Jun. 2, 2006
(86) PCT No.: PCT/EP06/62853

§ 371 Date: Jul. 1, 2008

(30) Foreign Application Priority Data
Jun. 4, 2005 (DE) 10 2005 025 718.6
Jun. 22, 2005 (DE) 10 2005 029 309.3

(51) Int. Cl. C08K 3/10; C09C 1/02

(52) U.S. Cl. 524/423; 516/98

(57) ABSTRACT

The invention discloses a dispersion of deagglomerated barium sulphate having an average primary particle size of <0.5 μm and coated with a dispersant in defined organic solvents, especially halogenated solvents such as dichloromethane. The dispersant preferably has reactive groups which are able to interact with the surface of the barium sulphate; particularly preferred dispersants are those which are able to endow the barium sulphate with a hydrophilic surface and which have reactive groups for coupling to or into polymers. The dispersion lends itself very well to incorporation into polymers such as acrylates, methacrylates, or particularly into hydrophobic polymers such as polycarbonate, or precursors thereof.

The present invention relates to a dispersion of deagglomerated barium sulphate in a halogenated organic solvent, an ether or ester and to its preparation and use.

The use of barium sulphate as a filler for plastics is already known. International patent application WO 00/14165 discloses the preparation of barium sulphate embedded in finely divided form in a carrier material. The particle size is 0.01 to 10 μm; they have good properties in connection with matting. Production takes place by wet fine milling in the presence of the carrier material.

International patent application WO 02/30994 discloses the addition of an inorganic barium sulphate of this kind to raw materials for polymers, prior to the formation of polymer. The preferred average particle size D₅₀ of the inorganic solid embedded into the organic substance is 0.25 to 0.45 μm. The additive compositions are used in polyester and polyamide.

International patent application WO 00/57932 discloses materials for surgical application that contain what is referred to as nanocomposites. The filler particles can be treated with organic compounds in order to enhance their dispersibility, to reduce their propensity to agglomerate or aggregate, and to enhance the uniformity of the dispersion. Examples of compounds employed for this purpose include organic compounds such as the monomer of the surgical material under production, citrates or other compounds. Use may also be made of coupling agents such as organosilanes or of polymeric materials such as surfactants, an example being sodium dodecyl sulphate, but also of amphiphilic molecules, i.e. molecules which have a hydrophilic part and a hydrophobic part. Those specified include nonylphenol ethoxylates; bis(2-ethylhexyl) sulphosuccinate; hexadecyltrimethylammonium bromide; and phospholipids. The examples use either uncoated barium sulphate or particles coated with sodium citrate following precipitation.

The international patent application filed as PCT/EP04/013612, unpublished at the priority date of the present specification, discloses a finely divided, deagglomerated barium sulphate which is redispersible even after drying and which lends itself well to incorporation into plastics. The deagglomerated barium sulphate described therein comprises a crystallization inhibitor and a dispersant. It can also be present in the form of a dispersion in solvents. Halogenated compounds, ethers or esters as solvents are not specified.

It is an object of the present invention to specify a new dispersion of the deagglomerated barium sulphate described in PCT/EP04/013612 in a solvent that can be incorporated into a polymer or a polymer precursor. This object is achieved by means of the dispersion of the present invention.

The invention provides a dispersion comprising a dispersant and based on a halogen-substituted organic liquid, an ether or a carboxylic ester as continuous phase, comprising as its dispersed phase deagglomerated barium sulphate having primary particles with an average size of <0.5 μm, the primary particles in turn optionally comprising a crystallization inhibitor.

The preparation of the barium sulphate described in PCT/EP04/013612 is elucidated below.

Preference is given to deagglomerated barium sulphate having an average (primary) particle size of <0.1 μm, particularly <0.08 μm (i.e. 80 nm), with very particular preference <0.05 μm (i.e. 50 nm), more preferably still <0.03 μm (i.e. 30 nm). Outstanding particles are those with sizes <20 μm, especially those with an average primary particle size of <10 nm. The lower limit on the primary particle size is for example 5 nm, but may also be even lower. The particle sizes in question are average particle sizes as determined by XRD or laser diffraction methods. A preferred barium sulphate is obtainable by precipitating barium sulphate in the presence of a crystallization inhibitor, with a dispersant present during the precipitation and/or with the barium sulphate being deagglomerated postprecipitation in the presence of a dispersant.

The amount of crystallization inhibitor and dispersant in the deagglomerated barium sulphate is flexible. Per part by weight of barium sulphate it is possible for there to be up to 2 parts by weight, preferably up to 1 part by weight, each of crystallization inhibitor and dispersant. Crystallization inhibitor and dispersant are present preferably in an amount of 1% to 50% by weight each in the deagglomerated barium sulphate. The amount of the barium sulphate present is preferably from 20% to 80% by weight.

It is known that in the course of its conventional preparation barium sulphate forms agglomerates (“secondary particles”) made up of primary particles. The term “deagglomerated” in this context does not mean that the secondary particles have been broken down completely into primary particles which exist in isolation. It means that the secondary barium sulphate particles are not in the same agglomerated state in which they are typically produced in precipitations, but instead are in the form of smaller agglomerates. The deagglomerated barium sulphate of the invention preferably contains agglomerates (secondary particles) which have an average particle size of less than 2 μm, preferably less than 1 μm. With preference it is smaller than 250 nm, with very particular preference smaller than 200 nm. More preferably still the secondary particles are smaller than 130 nm, with particular preference smaller than 100 nm, with very particular preference smaller than 80 nm; more preferably still the secondary particles are less than 50 nm, and even <30 nm. In part or even in substantial entirety the barium sulphate is in the form of unagglomerated primary particles. The average particle sizes in question are those determined by XRD or laser diffraction methods.

A corresponding barium sulphate having an average primary particle size <50 nm, preferably <30 nm, in particular <20 nm, very particularly <10 nm preferably has a BET surface area of at least 30 m²/g, in particular at least 40 m²/g, with particular preference at least 45 m²/g and with very particular preference at least 50 m²/g.

Preferred crystallization inhibitors have at least one anionic group. The anionic group of the crystallization inhibitor is preferably at least one sulphate, at least one sulphonate, at least one (preferably at least two) phosphate, at least two phosphonate or at least two carboxylate group(s).

Crystallization inhibitors present may be, for example, substances that are known to be used for this purpose, examples being relatively short-chain or else longer-chain polyacrylates, typically in the form of the sodium salt; polyethers such as polyglycol ethers; ether sulphonates such as lauryl ether sulphonate in the form of the sodium salt; esters of phthalic acid and of its derivatives; esters of polyglycerol; amines such as triethanolamine; and esters of fatty acids, such as stearic esters, as specified in WO 01/92157.

As crystallization inhibitor it is also possible to use a compound of the formula (I) or a salt thereof, having a carbon chain R and n substituents [A(O)OH]

R[-A(O)OH]ₙ (I)

in which

R is an organic radical which has hydrophobic and/or hydrophilic moieties, R being a low molecule mass, oligomeric or polymeric, optionally branched and/or cyclic carbon chain which optionally contains oxygen, nitrogen, phosphorus or sulphur heteroatoms, and/or being substituted by radicals which are attached via oxygen, nitrogen, phosphorus or sulphur to the radical R, and

A being C, P(OH), OP(OH), S(O) or OS(O), and n being 1 to 10 000.

In the case of monomeric or oligomeric compounds, n is preferably 1 to 5.

Useful crystallization inhibitors of this kind include carboxylic acid compounds, particularly those that are substituted by at least one hydroxyl group. Highly useful examples include hydroxy-substituted monocarboxylic and dicarboxylic acids. Such carboxylic acids preferably have 1 to 20 carbon atoms in the chain (reckoned without the carbon atoms of the COO groups), such as citric acid, malic acid (2-hydroxybutane-1,4-dioic acid), dihydroxysuccinic acid and 2-hydroxyoleic acid, for example. Very particular preference is given to citric acid and polyacrylate as crystallization inhibitor.

Also extremely useful are phosphonic acid compounds having an alkyl (or alkylene) radical with a chain length of 1 to 10 carbon atoms. Useful compounds in this context are those having one, two or more phosphonic acid radicals. They may additionally be substituted by hydroxyl groups. Highly useful examples include 1-hydroxyethylenediphosphonic acid, 1,1-diphosphonopropane-2,3-dicarboxylic acid and 2-phosphonobutane-1,2,4-tricarboxylic acid. These examples show that compounds having not only phosphonic acid radicals but also carboxylic acid radicals are likewise useful.

Also very useful are compounds which contain 1 to 5 or an even greater number of nitrogen atoms and also 1 or more, for example up to 5, carboxylic acid or phosphonic acid radicals and which are optionally substituted additionally by hydroxyl groups. These include, for example, compounds having an ethylenediamine or diethylenetriamine framework and carboxylic acid or phosphonic acid substituents. Examples of highly useful compounds include diethylentriaminepentakis(methanephosphonic acid), iminodisuccinic acid, diethylenetriaminepentaacetic acid and N-(2-hydroxyethyl)ethylenediamine-N,N,N-triacetic acid.

Also very useful are polyamino acids, an example being polyaspartic acid.

Also extremely useful are sulphur-substituted carboxylic acids having 1 to 20 carbon atoms (reckoned without the carbon atoms of the COO group) and 1 or more carboxylic acid radicals, an example being sulphosuccinic acid bis-2-ethylhexyl ester (dioctyl sulphosuccinate).

The crystallization inhibitor is preferably an optionally hydroxy-substituted carboxylic acid having at least two carboxylate groups; an alkyl sulphate; an alkylbenzenesulphonate; a polyacrylic acid; a polyaspartic acid; an optionally hydroxy-substituted diphosphonic acid; ethylenediamine or diethylenetriamine derivatives containing at least one carboxylic acid or phosphonic acid and optionally substituted by hydroxyl groups; or salts thereof.

It is of course also possible to use mixtures of the additives, including mixtures, for example, with further additives such as phosphorous acid.

The preparation of the above-described barium sulphate intermediate with the crystallization inhibitors, particularly those of the formula (I), is advantageously carried out by precipitating the barium sulphate in the presence of the envisaged crystallization inhibitor. It can be advantageous if at least part of the inhibitor is deprotonated; for example, by using the inhibitor at least in part, or entirely, as an alkali metal salt, a sodium salt for example, or as an ammonium salt. Naturally it is also possible to use the acid and to add a corresponding amount of the base, or in the form of an alkali metal hydroxide solution.

The deagglomerated barium sulphate comprises not only the crystallization inhibitor but also an agent which has a dispersing action. This dispersant prevents the formation of undesirably large agglomerates when added during the actual precipitation. As will be described later on below, it can also be added in a subsequent deagglomeration stage; it prevents reagglomeration and ensures that agglomerates are readily redispersed.

The dispersant preferably has one or more anionic groups which are able to interact with the surface of the barium sulphate. Such anionic groups will act as anchor groups for the surface of the barium sulphate particles. Preferred groups are the carboxylate group, the phosphate group, the phosphonate group, the bisphosphonate group, the sulphate group and the sulphonate group.

Dispersants which can be used include some of the above-mentioned agents which as well as a crystallization inhibitor effect also have a dispersing effect. When agents of this kind are used, it is possible for crystallization inhibitor and dispersant to be identical. Suitable agents can be determined by means of routine tests. The consequence of agents of this kind with a crystallization inhibitor and dispersing effect is that the precipitated barium sulphate is obtained as particularly small primary particles and forms readily redispersible agglomerates. Where an agent of this kind having both crystallization inhibitor and dispersing effect is used, it may be added during the precipitation and, if desired, deagglomeration may additionally be carried out in its presence.

It is usual to use different compounds having crystallization inhibitor action and dispersing action.

Very advantageous deagglomerated barium sulphate is that comprising dispersants of a kind which endow the barium sulphate particles with a surface which prevents reagglomeration and/or inhibits agglomeration electrostatically, sterically, or both electrostatically and sterically. Where such a dispersant is present during the actual precipitation, it inhibits the agglomeration of the precipitated barium sulphate, so that deagglomerated barium sulphate is obtained even at the precipitation stage. Where such a dispersant is incorporated after the precipitation, as part of a wet-grinding operation, for example, it prevents the reagglomeration of the deagglomerated barium sulphate after the deagglomeration. Barium sulphate comprising a dispersant of this kind is especially preferred on account of the fact that it remains in the deagglomerated state.

A particularly advantageous deagglomerated barium sulphate is characterized in that the dispersant has carboxylate, phosphate, phosphonate, bisphosphonate, sulphate or sulphonate groups which are able to interact with the barium sulphate surface (anchor group for the surface of the barium sulphate particles), and in that it has one or more organic radicals R¹ which have hydrophobic and/or hydrophilic moieties.

Preferably R¹ is a low molecular mass, oligomeric or polymeric, optionally branched and/or cyclic carbon chain which optionally contains oxygen, nitrogen, phosphorus or sulphur heteroatoms and/or is substituted by radicals which are attached via oxygen, nitrogen, phosphorus or sulphur to the radical R¹ and the carbon chain is optionally substituted by hydrophilic or hydrophobic radicals. One example of substituent radicals of this kind are polyether or polyester based side chains. Preferred polyether based side chains have 3 to 50, preferably 3 to 40, in particular 3 to 30 alkyleneoxy groups. The alkyleneoxy groups are preferably selected from the group consisting of methyleneoxy, ethyleneoxy, propyleneoxy and butyleneoxy groups. The length of the polyether based side chains is generally from 3 to 100 nm, preferably from 10 to 80 nm.

Preferred barium sulphate comprises a dispersant which has groups for coupling to or into polymers. Such groups will act as anchor groups for the polymer matrix. These may be groups which bring about this coupling chemically, examples being OH, NH, NH₂, SH, O—O peroxo, C—C double bond or 4-oxybenzonphenone propylphosphonate groups. The groups in question may also be groups which bring about physical coupling.

An example of a dispersant which renders the surface of the barium sulphate hydrophobic is represented by phosphoric acid derivatives in which one oxygen atom of the P(O) group is substituted by a C3-C10 alkyl or alkenyl radical and a further oxygen atom of the P(O) group is substituted by a polyether side chain. A further acidic oxygen atom of the P(O) group is able to interact with the barium sulphate surface.

The dispersant may be, for example, a phosphoric diester having a polyether or a polyester based side chain and an alkenyl group as moieties. Alkenyl groups with 4 to 12, in particular 4 to 6 carbon atoms are highly suitable. Phosphoric esters with polyether/polyester side chains such as Disperbyk® 111, phosphoric ester salts with polyether/alkyl side chains such as Disperbyk®102 and 106, substances having a deflocculating effect, based for example on high molecular mass copolymers with groups possessing pigment affinity, such as Disperbyk® 190, or polar acidic esters of long-chain alcohols, such as Disperplast® 1140, are further highly useful types of dispersants.

A barium sulphate having especially good properties comprises as dispersant a polymer which has anionic groups which are able to interact with the surface of the barium sulphate (anchor groups for the surface of the barium sulphate particles), examples being the groups specified above, and contains groups for coupling to or into polymers, such as OH, NH, NH₂, SH, O—O peroxo, C—C double bond or 4-oxybenzonphenone propylphosphonate groups (anchor groups for the polymer matrix). Preferably there are polyether or polyester based side chains present which contain OH, NH, NH₂, SH, O—O peroxo, C—C double bond or 4-oxybenzonphenone propylphosphonate groups. Barium sulphate of this kind according to the invention exhibits no propensity to reagglomerate. In the course of the application there may even be further deagglomeration.

As a result of the substitution with polar groups, especially hydroxyl groups and amino groups, the barium sulphate particles are externally hydrophilicized.

Preferred dispersants contain at least one anionic group which will act as an anchor group for the surface of the barium sulphate particles, at least one polyether or polyester based side chain that prevents reagglomeration sterically, and at least one group which will act as an anchor group for the polymer matrix.

The groups used for coupling to or into polymers can be preferentially selected with regard to the nature of the polymer matrix. The polar groups, especially hydroxyl groups and amino groups, represent reactive groups which are suitable for coupling to or into epoxy resins in particular. Especially good properties are exhibited by a barium sulphate coated with a dispersant which has a multiplicity of polycarboxylate groups and a multiplicity of hydroxyl groups and also has further substituents which are sterically bulky, examples being polyether or polyester based chains. A very preferred group of dispersants, notably for nanoparticulate barium sulphate used as a filler in epoxy resins, are polyether polycarboxylates substituted terminally on the polyether based chains by hydroxyl groups. Hydroxyl groups are also notably suitable for coupling to or into polyurethanes. Hydroxyl groups and thiol groups can be used for coupling to or into polyvinylchloride (PVC). Another example is 4-oxybenzophenone propylphosphonate which can be used for coupling to or into polyolefines or PVC, O—O peroxo groups are useful anchor groups for unsaturated polyester or polyolefines. After admixture of the barium sulphate containing the dispersant to the resin, the reaction between the peroxo group and the resin is initiated. A further example is the use of C—C double bond for coupling to or into unsaturated polyesters.

Barium sulphate of this kind, having a crystal growth inhibitor and one of the particularly preferred dispersants that prevents reagglomeration sterically, especially a dispersant substituted by anchor groups for the polymer matrix as described above, has the great advantage that it comprises very fine primary particles and comprises secondary particles whose degree of agglomeration is low at most, these particles, since they are readily redispersible, having very good application properties—for example, they can be incorporated readily into polymers and do not tend towards reagglomeration, and indeed even undergo further deagglomeration in the course of the application.

International patent application PCT/EP04/013612 describes a number of methods for preparing the barium sulphate.

The first method envisages precipitating barium sulphate optionally in the presence of a crystallization inhibitor and then carrying out a deagglomeration in the solvent provided. This deagglomeration is carried out in the presence of a dispersant.

The second method envisages precipitating barium sulphate in the presence of an optional crystallization inhibitor and a dispersant. In the course of the subsequent deagglomeration in the solvent envisaged it is likewise possible for a dispersant to be present.

The first method is now elucidated in more detail.

Barium sulphate is precipitated by typical methods, such as by reacting barium chloride or barium hydroxide with alkali metal sulphate or sulphuric acid. In the course of this precipitation, methods are employed in which primary particles are formed with the fineness indicated above. In the course of the precipitation, additives may be employed which inhibit crystallization, examples being those as specified in WO 01/92157, or the aforementioned compounds of the formula (I) which have a crystallization inhibitor effect. The precipitated barium sulphate is then dried, for example spray-dried.

The second method of preparing the redispersible barium sulphate envisages carrying out the precipitation, for example by reacting barium chloride or barium hydroxide with alkali metal sulphate or sulphuric acid, optionally in the presence of a crystallization inhibitor and in the presence of a dispersant; this procedure leads to the formation of readily redispersible deagglomerated barium sulphate during the actual precipitation. Dispersants of this kind, which endow the barium sulphate particles with a surface which prevents reagglomeration and inhibits agglomeration during the precipitation electrostatically, sterically, or both electrostatically and sterically, have been elucidated earlier on above. This embodiment produces deagglomerated barium sulphate as early as during the precipitation stage. The thus-precipitated barium sulphate, comprising an optional crystallization inhibitor and a dispersant, is dried, by means of spray drying, for example.

There now follows a wet deagglomeration in the desired halogenated organic solvent, or in ether, or in ester, in a stirring or mixing apparatus or a mill, such as in a bead mill, a vibratory mill, an agitator-mechanism mill, a planetary ball mill or a dissolver with glass spheres for example, in order to generate the dispersion. Where barium sulphate produced in accordance with the first method is dispersed, a dispersant is added in every case in this wet deagglomeration. Where barium sulphate produced in accordance with the second method is dispersed, the addition of dispersant is a possibility. The dispersants have been specified above; by way of example it is possible to use an agent of the formula (I) that has dispersing properties. In this case the crystallization inhibitor and the dispersant may be the same. The crystallization inhibitor effect is used in the course of the precipitation, the dispersing effect in the course of the deagglomeration. For the preparation of the dispersion it is preferred to use those dispersants which contain at least one polyether or polyester based side chain and which therefore prevent reagglomeration sterically. Especially suitable dispersants contain OH, NH, NH₂, SH, O—O peroxo, C—C double bond or 4-oxybenzonphenone propylphosphonate groups which will act as anchors for the polymer matrix. The groups used for coupling to or into polymers can be preferentially selected with regard to the nature of the polymer matrix.

The grinding in the organic solvent and hence the deagglomeration are carried out until the desired degree of deagglomeration has been reached. The deagglomeration is preferably carried out until the deagglomerated barium sulphate of the invention comprises secondary particles having an average diameter of smaller than 2 μm, preferably smaller than 1 μm, with particular preference smaller than 250 nm, with very particular preference smaller than 200 nm. With even greater preference deagglomeration is carried out until it is less than 130 nm, with particular preference less than 100 nm, with very particular preference less than 80 nm, more preferably still <50 nm. The barium sulphate in this case may in part or even in substantial entirety be present in the form of unagglomerated primary particles (average particle sizes, determined by XRD or laser diffraction methods). In the method of the invention it is preferred to use a dispersion which comprises barium sulphate with an average primary particle size <50 nm, preferably <20 nm, which is substantially agglomerate-free, and in which, therefore, the average secondary particle size is not more than 30% greater than the average primary particle size.

Within the dispersion, the deagglomerated barium sulphate is present preferably in an amount of 0.1% to 70%, preferably 1% to 60%, in particular 10% to 60%, for example 10% to 25% or 10% to 20% by weight.

The halogenated organic solvent, the ether or the ester is selected with regard to the intended application. It must be compatible with the plastic or with the plastics precursor: for example, it must not exhibit unwanted reaction, and it must be sufficiently soluble therein.

Where dispersions in ethers are used, highly suitable ethers include dialkyl ethers in which alkyl is C₁-C₄, such as diethyl ether or dipropyl ether, cyclic alkyl ethers such as tetrahydrofuran or ethers of glycols, diglycol, glycerol or di-, tri- or polyglycerol, such as dialkylene glycol dialkyl ethers, in which alkylene is preferably ethylene, propylene and butylene and alkyl is C₁-C₄ alkyl, such as dipropylene glycol dimethyl ether.

Where carboxylic esters are used as solvents, highly suitable such esters are C₁-C₄ alkyl esters of carboxylic acids having a total of 2 to 4 carbon atoms in the carboxylic acid radical, preferably those of acetic acid (with 2 carbon atoms in the carboxylic acid radical), examples being methyl acetate, ethyl acetate, propyl acetate and butyl acetate.

Halogenated organic solvents are particularly preferred. The halogenated organic solvents are preferably aliphatic or aromatic halocarbon compound or aliphatic or aromatic hydrohalocarbon compound or a mixture thereof. Halogenated organic solvents used are one or more halocarbon compounds selected from the group consisting of chlorocarbons, chlorofluorocarbons, hydrochlorocarbons, hydrofluorocarbons and hydrochlorofluorocarbons. Halocarbon compounds are selected from the group consisting of linear and branched alkane compounds having 1 to 6 carbon atoms, and particularly those containing at least 1 hydrogen. Dichloromethane possesses excellent suitability. Besides the aliphatic halogenated (hydro)carbon compounds employed with preference it is also possible to use aromatic halogenated compounds such as o-dichlorobenzene.

The present invention also relates to a process for preparing a dispersion of deagglomerated barium sulphate. In a first embodiment, precipitated, dried barium sulphate (primary particle size of <0.5 μm) is deagglomerated in the presence of a dispersant and of a halogenated organic solvent, an ether, a carboxylic ester or a mixture thereof, starting from barium sulphate optionally precipitated in the presence of a crystallization inhibitor. In a second embodiment, precipitated, dried barium sulphate (primary particle size of <0.5 μm) precipitated in the presence of a dispersant which inhibits agglomeration and/or prevents reagglomeration and an optional crystallization inhibitor is deagglomerated in the presence of the halogenated organic solvent liquid, the ether, the carboxylic ester or a mixture thereof.

Dispersing barium sulphate in the halogenated organic solvent, ether or ester allows dispersed barium sulphate to be incorporated into plastics and prepolymers in which the introduction of powder or in which the aqueous or alcoholic suspensions mentioned in PCT/EP04/013612 is unsatisfactory or in which use of the dispersions of the invention is desirable for other reasons. For example, a dispersion containing dichloromethane as its continuous phase can be used for incorporating barium sulphate filler into polyacrylate; particular advantage attaches to using dispersions in halocarbon compounds such as dichloromethane for introduction into hydrophobic plastics such as polycarbonate or PVC. Following incorporation, the solvent can be removed by evaporation. The solids content in the polymers or prepolymers is typically between 20% and 80% by weight.

The dispersion of deagglomerated barium sulphate of the invention is suitable for the introduction of barium sulphate into adhesives and into plastics, for example, such as acrylates or methacrylates, or into hydrophobic plastics such as polycarbonate or PVC or precursors thereof. The dispersion of the invention results in homogeneous distribution of the barium sulphate.

Therefore, the present invention also relates to the use of the dispersion of deagglomerated barium sulphate described above for producing plastics and adhesives.

The examples which follow are intended to illustrate the invention without restricting it in its scope.

### EXAMPLES

Preparation takes place as described in PCT/EP04/013612.

### Example 1

### Preparation of Finely Divided Barium Sulphate as an Intermediate by Precipitation in the Presence of Crystallization Inhibitors

### General Experimental Instructions:

a) Routine experiment:

A high 600 ml glass beaker is charged with 200 ml of additive solution (containing 2.3 g of citric acid and 7.5 g of Melpers®0030) and 50 ml of sodium sulphate solution with a concentration of 0.4 mol/l. Stirring is carried out centrally in the solution by means of an Ultraturrax stirrer as dispersing aid at 5000 rpm. In the vortex region of the Ultraturrax the barium chloride solution (concentration: 0.4 mol/l) is supplied by means of a Dosimat automatic metering device.
b) The example described as 1a) is repeated but using 200 ml of additive solution containing 2.3 g of citric acid and 50 ml of sodium sulphate solution, but no Melpers®0030.
c) Unit (V):

An apparatus is used as described in WO 01/92157, in which forces of thrust, shear and friction act on the reaction mixture. The crystallization inhibitor (see Table below) is added to the initial charge of the sulphate solution.

| | | | | | | d 50 |
|---|---|---|---|---|---|---|
| | | | | | | without |
| trade name of | | | | | | pretreatment |
| the | chemical identity | amount of | | BET | XRD | of |
| crystallization | according | additive | pH of | value | value | suspension |
| inhibitor | to manufacturer | [%] | suspension | [m²/g] | d [nm]* | [μm]** |
| Citronensäure, | citric acid | 7.5 | 12.43 | 75.2 | 22 | 0.287 |
| Merck | | | | | | |
| Citronensäure, | citric acid | 15 | 7.13 | 73 | 18 | 0.142 |
| Merck | | | | | | |
| HEDP, Fluka | 1-hydroxy- | 21.6 | 5.9 | 63.4 | 16 | 0.228 |
| | ethylenediphosphonic | | | | | |
| | acid tetrasodium salt | | | | | |
| Baypur CX | iminodisuccinic | 15 | 9.6 | 55.9 | 22 | 1.281 |
| 100/34% | acid sodium salt in | | | | | |
| | aqueous solution | | | | | |
| Dispex N40, | neutral sodium salt | 3 | 12.85 | 53.9 | 28 | 0.167 |
| Ciba | of a polycarboxylic | | | | | |
| | acid (polyacrylate), | | | | | |
| | molar weight | | | | | |
| | approx. 3500 Da, | | | | | |
| | lowest molar weight | | | | | |
| | of the Dispex series | | | | | |
| Citritex 85, | Na salt of | 15 | 6.6 | 53.6 | 31 | 0.273 |
| Jungbunzlauer | hydroxycarboxylic | | | | | |
| Ladenburg | acids | | | | | |
| GmbH | | | | | | |
| HEDP | 1-hydroxy- | 10.8 | 5.6 | 53.4 | 23 | 0.243 |
| | ethylenediphosphonic | | | | | |
| | acid tetrasodium salt | | | | | |
| DTPA-P, Fluka | diethylenetriamine | 15 | 6.97 | 52.6 | 17 | 0.169 |
| | pentakis (methane- | | | | | |
| | phosphonic acid) | | | | | |
| | solution | | | | | |
| DTPA | diethylenetriamine | 15 | 11.3 | 47.8 | 29 | 0.23 |
| | pentaacetic acid | | | | | |
| DEVItec PAA | polyaspartic acid, | 15 | 5.73 | 47.7 | 18 | 0.296 |
| | Na salt, in aqueous | | | | | |
| | solution | | | | | |
| Dispex N40 | neutral sodium salt | 15 | 10.67 | 46.6 | 19 | 0.167 |
| | of a polycarboxylic | | | | | |
| | acid (polyacrylate), | | | | | |
| | molar weight approx. | | | | | |
| | 3500 Da, lowest molar | | | | | |
| | weight of the Dispex | | | | | |
| | series | | | | | |
| HEDTA | N-(2-(hydroxy- | 3.75 | 8.3 | 46.5 | 38 | 0.317 |
| | ethyl)ethylene- | | | | | |
| | diamine-N,N,N,- | | | | | |
| | triacetic acid | | | | | |
| 4334/HV, | polycarboxylate, | 15 | 9.9 | 33 | 21 | 0.147 |
| SKW | aqueous | | | | | |
| Citronensäure | citric acid | 1.5 | 6.1 | 32.1 | 33 | 1.588 |
| Dispex N40 | neutral sodium salt | 15 | 10.08 | 32 | 21 | 0.2 |
| | of a polycarboxylic | | | | | |
| | acid (polyacrylate), | | | | | |
| | molar weight approx. | | | | | |
| | 3500 Da, lowest molar | | | | | |
| | weight of the Dispex | | | | | |
| | series | | | | | |
| DTPA-P, Fluka | diethylenetriamine | 5 | 11.38 | 31.5 | 29 | 0.197 |
| | pentakis (methane- | | | | | |
| | phosphonic acid) | | | | | |
| | solution | | | | | |
| HEDP | 1-hydroxyethylene- | 15 | 2.99 | 30.3 | 34 | 0.364 |
| | diphosphonic acid | | | | | |
| | tetrasodium salt | | | | | |
| 4334/HV | polycarboxylate, | 15 | 6.84 | 30.2 | 23 | 0.152 |
| | aqueous | | | | | |
| DTPA-P | diethylenetriamine | 15 | 10.47 | 25.5 | 17 | 0.157 |
| | pentakis (methane- | | | | | |
| | phosphonic acid) | | | | | |
| | solution | | | | | |
| Äpfelsäure, | 2-hydroxybutane- | 15 | 10.47 | 24.2 | 28 | 1.031 |
| Merck | 1,4-dioic acid | | | | | |
| Polymethacrylsäure | polymethacrylic | 5 | 10.69 | 18.9 | 40 | 0.268 |
| 91 | acid | | | | | |
| Sokalan PA20 | Polyacrylate | 15 | 6.31 | 15.7 | 22 | 0.251 |
| Dispers 715W | Na polyacrylate, | 15 | 5.99 | 15.1 | 19 | 0.18 |
| | aqueous | | | | | |
| Hydropalat N | Na polyacrylate | 15 | 6.03 | 12.5 | 23 | 0.168 |
| VP 4334/8L | polycarboxylate, | 15 | 6.38 | 12.5 | 24 | 0.148 |
| | aqueous | | | | | |
| Dispers 715W | Na polyacrylate, | 15 | 10.82 | 12.4 | 19 | 0.161 |
| | aqueous | | | | | |

*The XRD value corresponds to the average primary particle size diameter measured by XRD
**d 50 without pretreatment of suspension corresponds to the average particle size diameter of barium sulphate particles, including both primary and secondary particles.

The above table shows further suitable crystallization inhibitors which in some cases can also be used as dispersants.

### Example 2

### Preparation of Barium Sulphate by Precipitation in the Presence of Crystallization Inhibitors and Polymeric Dispersants During Precipitation

Starting materials used were barium chloride and sodium sulphate.

### 2.1. Beaker Experiments:

A 200 ml graduated flask is charged with 7.77 g of the Melpers-type, terminally hydroxy-substituted polyether polycarboxylate (Melpers®0030) from SKW and made up to 200 ml with water. This quantity corresponds to 50% of Melpers (30% aqueous solution) based on the maximum amount of BaSO₄ formed (=4.67 g).

A 600 ml high glass beaker is charged with 50 ml of a 0.4 M BaCl₂ solution, to which the 200 ml of the Melpers solution are added. To aid dispersion an Ultraturrax is immersed centrally into the glass beaker and operated at 5000 rpm. Within the vortex region created by the Ultraturrax 50 ml of a 0.4 M Na₂SO₄ solution to which citric acid has been added (50% of citric acid, based on the maximum amount of BaSO₄ formed: 2.33 g per 50 ml/Na₂SO₄) are added via a flexible tube, using a Dosimat. Both the BaCl₂/Melpers solution and the Na₂SO₄/citric acid solution are rendered alkaline using NaOH prior to precipitation; the pH is approximately 11-12.

The barium sulphate obtained in deagglomerated form possesses a primary particle size of approximately 10 to 20 nm; the secondary particle size is in the same range, and so the barium sulphate is regarded as largely free of agglomerate.

### 2.2. Preparation of Deagglomerated Barium Sulphate on the Pilot Plant Scale

A 30 l vessel is charged with 5 l of a 0.4 M BaCl₂ solution. 780 g of the Melpers product are added with stirring (50%, based on maximum amount of BaSO₄ formed: 467 g). To this solution there are added 20 l of demineralized water. Operated within the vessel is an Ultraturrax, in whose vortex region 5 l of a 0.4 M Na₂SO₄ solution are added via a stainless steel pipe, using a peristaltic pump. The Na₂SO₄ solution has been admixed with citric acid beforehand (233 g/5 l Na₂SO₄=50% citric acid, based on maximum amount of BaSO₄ formed). As in the case of the beaker experiments, both solutions have been rendered alkaline by means of NaOH prior to precipitation in these experiments as well. The properties in respect of primary particle size correspond to those of the barium sulphate from Example 2.1. The sulphate is likewise largely free from agglomerates.

2.3. Preparation of Deagglomerated Barium Sulphate with Higher Reactant Concentrations

Example 2.2 is repeated. On this occasion 1-molar solutions are used. The barium sulphate obtained corresponds to that of Example 2.2.

### Example 3

### Preparation of a Dispersion with Deagglomerated Barium Sulphate

### 3.1. Preparation of a Dispersion Using Melpers®0030

The barium sulphate prepared in accordance with Example 1 and Examples 2.1, 2.2 and 2.3 is dried and subjected to wet grinding in dichloromethane in a bead mill with addition of a dispersant. The dispersant used is a polyether polycarboxylate substituted terminally on the polyether side chains by hydroxyl groups (Melpers type from SKW, molar weight approximately 20 000, side chain 5800).

### 3.2. Preparation of a Dispersion Using Disperbyk®102

The example 3.1 is repeated but the dispersant used is a phosphoric ester having one free hydroxyl group, namely Disperbyk®102.

### Example 4

### Preparation of Barium Sulphate with Grinding

### 4.1. Preparation of Chemically Dispersed Barium Sulphate by Precipitation in the Presence of Crystallization Inhibitors and Subsequent Grinding in the Presence of Polymeric Dispersants

Starting materials used are barium chloride and sodium sulphate. Barium chloride solution (0.35 mol/l) and sodium sulphate solution (0.35 mol/l) are reacted in the presence of citric acid as crystallization inhibitor, with precipitation of barium sulphate. The precipitated barium sulphate is dried and suspended in propylacetate. A phosphoric ester having one free hydroxyl group (Disperbyk®102) is added as dispersant and the precipitated barium sulphate is further deagglomerated in a bead mill. The barium sulphate contains about 7.5% by weight of citric acid and about 15% by weight of the phosphoric ester.

### 4.2. Preparation Using Other Starting Compounds and a Different Crystallization Inhibitor

Example 4.1. is repeated. Barium chloride is replaced by barium hydroxide solution (0.35 mol/l) and sodium sulphate by sulphuric acid (0.35 mol/l). Instead of citric acid, 3% by weight of Dispex® N40 are used (a sodium polyacrylate). Disperbyk®102 was used in an amount of 8.5% by weight.

### Example 5

### Incorporation of Barium Sulphate Dispersions in Plastics

5.1. Use of a Dispersion in Dichloromethane for Incorporation into Polyacrylate

A dispersion prepared as described above and containing approximately 50% by weight of barium sulphate, agglomerate size <100 nm, in dichloromethane is mixed in polyacrylate dissolved in tetrahydrofuran, this mixing being brought about by stirring the components together. Subsequently the solvents are removed by distillation.

The amounts of dispersion and plastic are selected such that the finished plastic contains approximately 30% by weight of barium sulphate in dispersed form.

A further example is done in the same conditions, except that the amounts of dispersion and plastic are selected such that the finished plastic contains approximately 45% by weight of barium sulphate in dispersed form. This shows that ranges of 30 to 45% of barium sulphate in plastics is easily obtainable by this process.

5.2. Use of the Dispersion in Dichloromethane for Incorporation into Polycarbonate

The dispersion described in Example 5.1 is incorporated into a solution of polycarbonate in dichloromethane and then the solvent is evaporated off. This gives a homogeneous dispersion of the barium sulphate in the polycarbonate.

5.3. Use of a Dispersion in Tetrahydrofuran for Incorporation into Polyacrylate

Example 5.1. is repeated but using a dispersion of the barium sulphate in tetrahydrofuran.

1-25. (canceled)

26: A dispersion comprising a dispersant and based on a halogenated organic solvent, an ether or a carboxylic ester as continuous phase, comprising as its dispersed phase deagglomerated barium sulphate having primary particles with an average size of <500 nm, the primary particles in turn optionally comprising a crystallization inhibitor.

27: The dispersion according to claim 26, wherein the deagglomerated barium sulphate has primary particles with an average size of <100 nm.

28: The dispersion according to claim 26, wherein the barium sulphate contains primary and secondary barium sulphate particles, the secondary barium sulphate particles having an average particle size of smaller than 2000 nm.

29: The dispersion according to claim 26, wherein the barium sulphate contains primary and secondary barium sulphate particles, the secondary barium sulphate particles having an average particle size of <250 nm.

30: The dispersion according to claim 26, wherein a crystallization inhibitor is comprised and is selected from compounds having at least one anionic group.

31: The dispersion according to claim 30, wherein the anionic group of the crystallization inhibitor is at least one sulphate, at least one sulphonate, at least two phosphate, at least two phosphonate, at least two carboxylate group(s), or mixtures thereof.

32: The dispersion according to claim 26, wherein the crystallization inhibitor is a compound of the formula (I) or salt thereof having a carbon chain R and n substituents [A(O)OH]
R[-A(O)OH]ₙ (I)
in which R is an organic radical which has hydrophobic and/or hydrophilic moieties, R being a low molecular mass, oligomeric or polymeric, optionally branched and/or cyclic carbon chain which optionally contains oxygen, nitrogen, phosphorus or sulphur heteroatoms, and/or being substituted by radicals which are attached via oxygen, nitrogen, phosphorus or sulphur to the radical R, A being C, P(OH), OP(OH), S(O) or OS(O), and n being 1 to 10 000.

33: The dispersion according to claim 26, wherein the crystallization inhibitor is an optionally hydroxy-substituted carboxylic acid having at least two carboxylate groups; an alkyl sulphate; an alkylbenzenesulphonate; a polyacrylic acid; a polyaspartic acid; an optionally hydroxy-substituted diphosphonic acid; ethylenediamine or diethylenetriamine derivatives containing at least one carboxylic acid or phosphonic acid and optionally substituted by hydroxyl groups; or salts thereof.

34: The dispersion according to claim 26, wherein the dispersant has anionic groups which are able to interact with the surface of the barium sulphate.

35: The dispersion according to claim 26, wherein the dispersant has carboxylate, phosphate, phosphonate, bisphosphonate, sulphate or sulfonate groups.

36: The dispersion according to claim 34, wherein the dispersant has one or more organic radicals R¹ which have hydrophobic and/or hydrophilic moieties.

37: The dispersion according to claim 36, wherein R¹ is a low molecular mass, oligomeric or polymeric, optionally branched and/or cyclic carbon chain which optionally contains oxygen, nitrogen, phosphorus or sulphur heteroatoms and/or is substituted by radicals which are attached via oxygen, nitrogen, phosphorus or sulphur to the radical R¹ and the carbon chain is optionally substituted by hydrophilic or hydrophobic radicals.

38: The dispersion according to claim 36, wherein the dispersant is a phosphoric diester having a polyether based side chain and a C6 C10 alkenyl group as moieties.

39: The dispersion according to claim 36, wherein the dispersant has groups for coupling to or into polymers.

40: The dispersion according to claim 39, wherein the groups for coupling to or into polymers are selected from OH, NH, NH₂, SH, O—O peroxo, C—C double bond, 4-oxybenzophenone propylphosphonate groups or mixtures thereof.

41: The dispersion according to claim 40 wherein the dispersant has polyether or polyester based side chains.

42: The dispersion according to claim 41, wherein the polyether or polyester based side chains contain groups for coupling to or into polymers.

43: The dispersion according to claim 42, wherein the hydroxyl groups and amino groups function as reactive groups for coupling to or into epoxy resins.

44: The dispersion according to claim 42, wherein the dispersant is a polyether polycarboxylate which is substituted terminally on the polyether based side chains by hydroxyl groups.

45: The dispersion according to claim 26, wherein the crystallization inhibitor and the dispersant are each present in the dispersed deagglomerated barium sulphate or in the dispersion in an amount of up to 2 parts by weight per part by weight of barium sulphate.

46: The dispersion according to claim 26, wherein the crystallization inhibitor and the dispersant are each present in the dispersed deagglomerated barium sulphate or in the dispersion in an amount of 1% to 50% by weight of barium sulphate in each case.

47: The dispersion according to claim 26, wherein the continuous phase comprises an aliphatic or aromatic halocarbon compound or an aliphatic or aromatic hydrohalocarbon compound or a mixture thereof.

48: The dispersion according to claim 47, wherein the continuous phase comprises one or more halocarbon compounds selected from the group consisting of chlorocarbons, chlorofluorocarbons, hydrochlorocarbons, hydrofluoro-carbons and hydrochlorofluorocarbons.

49: The dispersion according to claim 48, wherein the halocarbon compounds are selected from the group consisting of linear and branched alkane compounds having 1 to 6 carbon atoms.

50: The dispersion according to claim 49, wherein the continuous phase comprises dichloromethane.

51: The dispersion according to claim 26, wherein the barium sulphate is present in an amount of 0.1% up to 70% by weight.

52: A process for preparing a dispersion of deagglomerated barium sulphate according to claim 26, wherein
a) precipitated, dried barium sulphate having a primary particle size of <0.5 m is deagglomerated in the presence of a dispersant and of a halogenated organic solvent, an ether, a carboxylic ester or a mixture thereof, starting from barium sulphate precipitated in the presence of a crystallization inhibitor, or
b) precipitated, dried barium sulphate having a primary particle size of <0.5 m precipitated in the presence of a crystallization inhibitor and of a dispersant which inhibits agglomeration and/or prevents reagglomeration is deagglomerated in the presence of the halogenated organic solvent, the ether, the carboxylic ester or a mixture thereof.

53: A method of use of the dispersion of deagglomerated barium sulphate according to claim 26 for producing plastics and adhesives.

54: A method of use of deagglomerated barium sulphate having an average primary particle size <500 nm and containing a dispersant and, optionally, a crystallization inhibitor, in dispersions based on halogenated organic solvents, ethers or esters.
